(19) United States
(12) Patent Application Publication
(10) Pub. No.: US 2022/0152790 A1
(43) Pub. Date: May 19, 2022

(54) SOUND PRODUCING DEVICE AND HAND TOOL USING THE SAME

(71) Applicant: Hong Ann Tool Industries Co., Ltd., Taichung City (TW)

(72) Inventor: Cheng-Wei SU, Taichung City (TW)

(21) Appl. No.: 17/484,172

(22) Filed: Sep. 24, 2021

(30) Foreign Application Priority Data
Nov. 16, 2020 (TW) 109139950

(51) Int. Cl. B25B 13/48; B25B 23/142

(52) U.S. Cl. CPC B25B 13/48; B25B 23/1427

(57) ABSTRACT

A sound producing device includes a sound wheel seat, a sound wheel, and a spring leaf. The sound wheel is rotatably disposed in the sound wheel seat and has a plurality of contacting teeth formed on an outer periphery thereof The spring leaf is mounted in the sound wheel seat and has a body portion and a contacting portion extending from the body portion and disposed between any two of the contacting teeth. The contacting portion is plucked by the contacting teeth to produce a sound when the sound wheel rotates relative to the sound wheel seat.

### BACKGROUND OF THE INVENTION

The present invention relates to a sound producing device and, more particularly, to a sound producing device for a hand tool which can produce sound while rotating to increase the pleasures of using the hand tool.

General hand tools, such as screwdrivers for tightening or loosening screws, wrenches for rotating screws, or torque wrenches for tightening screws with a specific torque, are powered by hand, which are convenient and lightweight. It is an indispensable appliance in operation, and has the advantages of convenient carrying and simple operation.

However, hand tools have no other functions except to solve the needs of work. Therefore, hand tools are only inanimate simple machines. People in modem society live a fast-paced and humdrum life, so that it needs to adjust mind appropriately to increase the pleasures of work.

In view of the above, a need exists for a sound producing device that mitigates and/or obviates the above drawbacks.

### BRIEF SUMMARY OF THE INVENTION

An objective of the present invention is to provide a sound producing device adapted to produce sound while rotating to increase the pleasures of work.

In an aspect of the invention, a sound producing device includes a sound wheel seat, a sound wheel, and a spring leaf. The sound wheel is rotatably disposed in the sound wheel seat and has a plurality of contacting teeth formed on an outer periphery thereof The spring leaf is mounted in the sound wheel seat and has a body portion and at least one contacting portion extending from the body portion and disposed between any two of the plurality of contacting teeth of the sound wheel. The at least one contacting portion is plucked by the plurality of contacting teeth to produce a sound when the sound wheel rotates relative to the sound wheel seat,

In an example, the sound wheel seat has a first receiving portion and a second receiving portion communicating with the first receiving portion. The first receiving portion is formed in the shape of a circular hole, and the sound wheel is rotatably disposed in the first receiving portion. The second receiving portion is formed in the shape of a sector hole, and the spring leaf is mounted in the second receiving portion. The at least one contacting portion extends from the second receiving portion into the first receiving portion to be disposed between any two of the plurality of contacting teeth.

In an example, the sound wheel seat further has a retaining hole communicating with the second receiving portion, and a retaining member connected to the retaining hole. Two opposite sides of the body portion of the spring leaf respectively abut against an inner wall of the second receiving portion and the retaining member.

In an example, the body portion of the spring leaf is arc-shaped.

In an example, the spring leaf has two contacting portions respectively extending integrally from two opposite ends of the body portion.

In an example, the spring leaf is made of metal, and the at least one contacting portion is configured to be resiliently restored to pivot relative to the body portion.

In an example, the sound wheel further has a penetrating hole formed in the shape of a non-circular hole and adapted to connect with a rotating rod of a hand tool.

In an example, the sound wheel seat further has two positioning holes formed on an outer periphery thereof and located on two opposite sides thereof, and two positioning members penetrating a body of a hand tool and fixedly connected to the two positioning holes.

In another aspect of the invention, a hand tool includes a body, a rotating rod rotatably mounted in the body an operating end formed at a distal end of the body, and a sound producing device including a sound wheel seat arranged in the body a sound wheel rotatably disposed in the sound wheel seat and connected to the rotating rod, and a spring leaf mounted in the sound wheel seat. The sound wheel is driven by the rotating rod to rotate relative to the sound wheel seat when the rotating rod rotates relative to the body. The sound wheel has a plurality of contacting teeth formed on an outer periphery thereof. The spring leaf has a body portion and at least one contacting portion extending from the body portion and disposed between any two of the plurality of contacting teeth of the sound wheel. The at least one contacting portion is plucked by the plurality of contacting teeth to produce a sound when the sound wheel rotates relative to the sound wheel seat.

In an example, a terminal end of the rotating rod is fixedly connected with a knob exposed out of the body, so that the rotating rod is configured to be driven by the knob to rotate relative to the body.

The present invention will become clearer in light of the following detailed description of illustrative embodiments of this invention described in connection with the drawings,

### DESCRIPTION OF THE DRAWINGS

FIG. 1 is a perspective view of a hand tool having a sound producing device of an embodiment according to the present invention.

FIG. 2 is a partial exploded perspective view of the hand tool of FIG. 1, and illustrates element arrangement of the sound producing device.

FIGS. 3 and 4 are cross-sectioned views of the hand tool of FIG. 1.

### DETAILED DESCRIPTION OF THE INVENTION

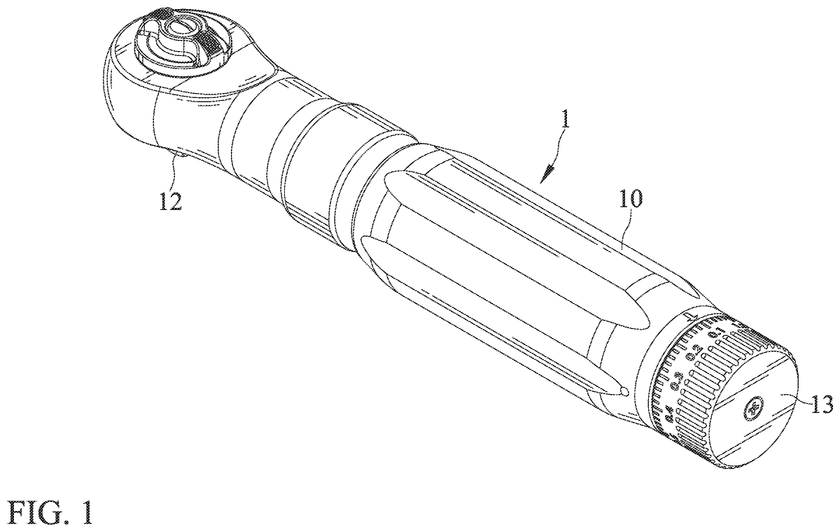

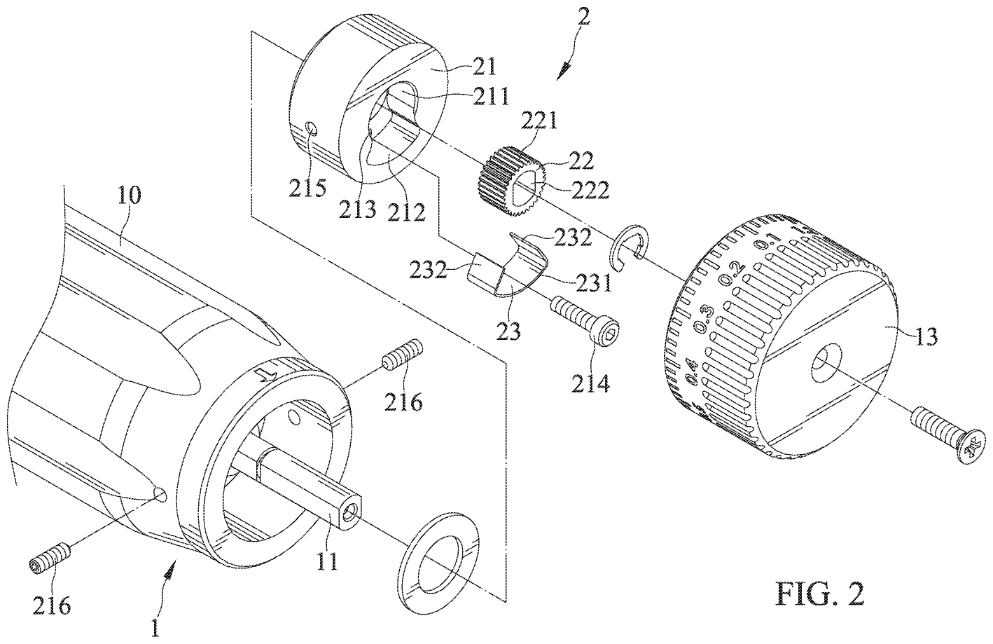

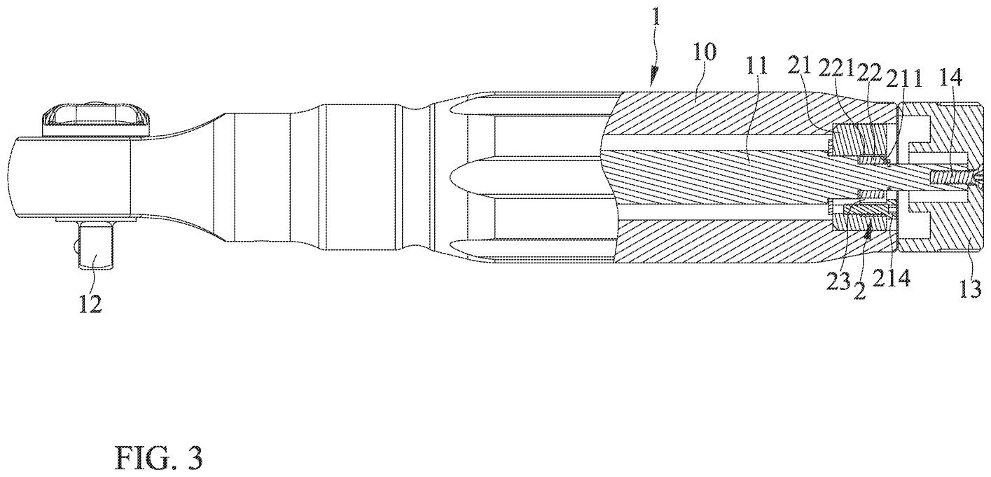

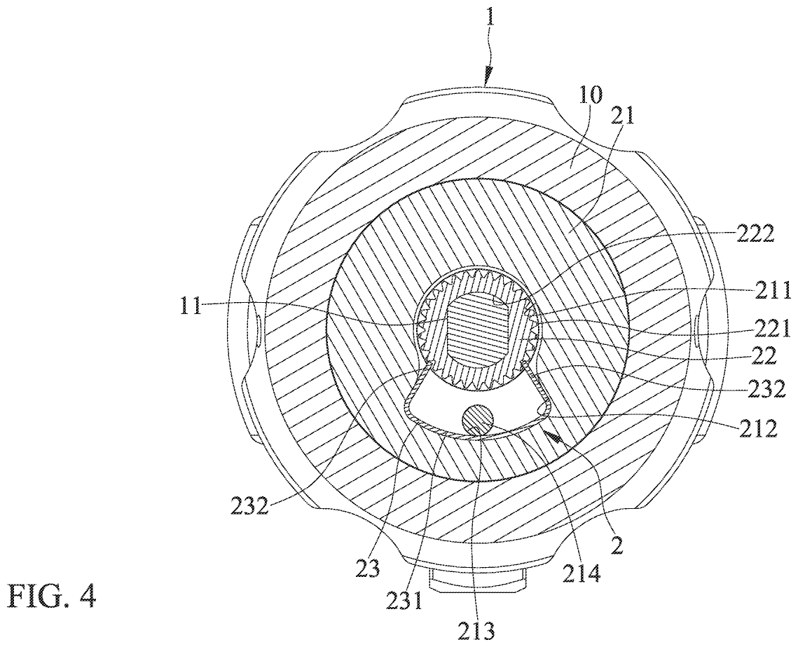

FIGS. 1-4 show a sound producing device 2 applied in a hand tool 1 of an embodiment according to the present invention. The sound producing device 2 includes a sound wheel seat 21, a sound wheel 22, and a spring leaf 23. For illustration, in this embodiment, the hand tool 1 is a torque wrench, which includes a body 10, a rotating rod 11, an operating end 12 and a knob 13. The sound producing device 2 of the embodiment is arranged in the body 10. The rotating rod 11 is rotatably mounted in the body 10 and connected to the sound wheel 22. The operating end 12 is formed at a distal end of the body 10 and adapted for driving a fastener (not shown). The knob 13 is fixedly connected with a terminal end of the rotating rod 11 and exposed out of the body 10 so when a user rotates the knob 13, the rotating rod 11 is driven by the knob 13 to rotate relative to the body 10, and the sound wheel 22 of the sound producing device 2 is driven by the rotating rod 11 to rotate relative to the sound wheel seat 21 and to pluck the spring leaf 23 to produce a sound.

The sound wheel seat 21 is configured to be arranged in the body 10 of the hand tool 1. The sound wheel seat 21 has a first receiving portion 211 and a second receiving portion 212 communicating with the first receiving portion 211. The first receiving portion 211 may be formed in the shape of a circular hole, and the sound wheel 22 is rotatably disposed in the first receiving portion 211. The second receiving portion 212 may be formed in the shape of a sector hole, and the spring leaf 23 is fixedly mounted in the second receiving portion 212 in an embed manner. The sound wheel seat 21 further has a retaining hole 213 communicating with the second receiving portion 212, and a retaining member 214 connected to the retaining hole 213. Furthermore, the sound wheel seat 21 further has two positioning holes 215 formed on an outer periphery thereof and located on two opposite sides thereof, and two positioning members 216 penetrating the body 10 of the hand tool 1 and fixedly connected to the two positioning holes 215 so that the sound wheel seat 21 can be arranged in the body 10.

The sound wheel 22 is configured to be connected to the rotating rod 11, so that the sound wheel 22 can be driven by the rotating rod 11 to rotate relative to the first receiving portion 211 of the sound wheel seat 21 when the rotating rod 11 rotates relative to the body 10. The sound wheel 22 has a plurality of contacting teeth 221 formed on an outer periphery thereof and a penetrating hole 222 formed in the shape of a non-circular hole. The penetrating hole 222 is adapted to sleevely connect to the rotating rod 11 of a hand tool 1 to cause the sound wheel 22 to be driven by the rotating rod 11.

The spring leaf 23 has a body portion 231 and at least one contacting portion 232 extending from the body portion 231 and disposed between any two of the plurality of contacting teeth 221 of the sound wheel 22. The at least one contacting portion 232 is plucked by the plurality of contacting teeth 221 to produce a sound when the sound wheel 22 rotates relative to the sound wheel seat 21. Further, the spring leaf 23 is made of metal to cause the at least one contacting portion 232 to be resiliently restored to pivot relative to the body portion 231. Two opposite sides of the body portion 231 respectively abut against an inner wall of the second receiving portion 212 and the retaining member 214, and the body portion 231 in the embodiment may be arc-shaped. The at least one contacting portion 232 extends from the second receiving portion 212 into the first receiving portion 211 to be disposed between any two of the plurality of contacting teeth 221. In the embodiment, the spring leaf 23 has two contacting portions 232 respectively extending integrally from two opposite ends of the body portion 231. Therefore, the metal spring leaf 23 can integrally form the body portion 231 and the two contacting portions 232 by bending.

Therefore, the sound wheel 22 of the sound producing device 2 can be driven by the rotating rod 11 to rotate relative to the sound wheel seat 21, so that the contacting portion 232 of the spring leaf 23 is plucked by the plurality of contacting teeth 221 of the sound wheel 22 to produce a rattling sound when the sound wheel 22 rotates relative to the sound wheel seat 21 to increase the pleasures of using the hand tool 1.

Although specific embodiments have been illustrated and described, numerous modifications and variations are still possible without departing from the scope of the invention. The scope of the invention is limited by the accompanying claims.

1. A sound producing device comprising:
a sound wheel seat;
a sound wheel rotatably disposed in the sound wheel seat and has a plurality of contacting teeth formed on an outer periphery thereof; and
a spring leaf mounted in the sound wheel seat and having a body portion and at least one contacting portion extending from the body portion and disposed between any two of the plurality of contacting teeth of the sound wheel, and wherein the at least one contacting portion is plucked by the plurality of contacting teeth to produce a sound when the sound wheel rotates relative to the sound wheel seat.

2. The sound producing device as claimed in claim 1, wherein the sound wheel seat has a first receiving portion and a second receiving portion communicating with the first receiving portion, wherein the first receiving portion is formed in the shape of a circular hole, and the sound wheel is rotatably disposed in the first receiving portion, wherein the second receiving portion is formed in the shape of a sector hole, and the spring leaf is mounted in the second receiving portion, wherein the at least one contacting portion extends from the second receiving portion into the first receiving portion to be disposed between any two of the plurality of contacting teeth.

3. The sound producing device as claimed in claim 2, wherein the sound wheel seat further has a retaining hole communicating with the second receiving portion, and a retaining member connected to the retaining hole, and wherein two opposite sides of the body portion of the spring leaf respectively abut against an inner wall of the second receiving portion and the retaining member.

4. The sound producing device as claimed in claim 3, wherein the body portion of the spring leaf is arc-shaped.

5. The sound producing device as claimed in claim 3, wherein the spring leaf has two contacting portions respectively extending integrally from two opposite ends of the body portion.

6. The sound producing device as claimed in claim 1, wherein the spring leaf is made of metal, and wherein the at least one contacting portion is configured to be resiliently restored to pivot relative to the body portion.

7. The sound producing device as claimed in claim 1, wherein the sound wheel further has a penetrating hole formed in the shape of a non-circular hole and adapted to connect to a rotating rod of a hand tool.

8. The sound producing device as claimed in claim 1, wherein the sound wheel seat further has two positioning holes formed on an outer periphery thereof and located on two opposite sides thereof, and two positioning members penetrating a body of a hand tool and fixedly connected to the two positioning holes.

9. A hand tool comprising:
a body;
a rotating rod rotatably mounted in the body;
an operating end formed at a distal end of the body; and
a sound producing device including a sound wheel seat arranged in the body, a sound wheel rotatably disposed in the sound wheel seat and connected to the rotating rod, and a spring leaf mounted in the sound wheel seat, wherein the sound wheel is driven by the rotating rod to rotate relative to the sound wheel seat when the rotating rod rotates relative to the body, wherein the sound wheel has a plurality of contacting teeth formed on an outer periphery thereof, wherein the spring leaf has a body portion and at least one contacting portion extending from the body portion and disposed between any two of the plurality of contacting teeth of the sound wheel, and wherein the at least one contacting portion is plucked by the plurality of contacting teeth to produce a sound when the sound wheel rotates relative to the sound wheel seat.

10. The hand tool as claimed in claim 9, wherein a terminal end of the rotating rod is fixedly connected with a knob exposed out of the body, and wherein the rotating rod is configured to be driven by the knob to rotate relative to the body.
